(19) United States
(12) Patent Application Publication
(10) Pub. No.: US 2010/0096790 A1
(43) Pub. Date: Apr. 22, 2010

(54) SLEEVE STRUCTURE

(76) Inventor: Jui-Min HUANG, Taichung City (TW)

Correspondence Address: EGBERT LAW OFFICES, 412 MAIN STREET, 7TH FLOOR, HOUSTON, TX, 77002, US

(21) Appl. No.: 12/253,971

(22) Filed: Oct. 18, 2008

(51) Int. Cl. B23Q 1/00

(52) U.S. Cl. 269/49

(57) ABSTRACT

The present invention provides an improved structure of a sleeve for labeling tools and fasteners. There is a sleeve body, containing a tool coupling end, an acting end and a cylinder. There is an identification ring, which is provided with a through hole for sleeving and positioning onto the cylinder of the sleeve body. A locating spring is provided with a connecting end and a positioning end. As the locating spring is positioned when the identification ring is sleeved onto the sleeve body, the identification ring has identification and positioning functions, so the sleeve with streamlined members has two additional efficacies: ease of identification and positioning, thereby helping to reduce the cost, and improve the applicability and industrial benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a sleeve structure for labeling tools and fasteners, and more particularly to an innovative sleeve with an identification ring and a locating spring. The locating spring is positioned securely via the identification ring.

2. Description of Related Art Including Information Disclosed Under 37 CFR 1.97 and 37 CFR 1.98

Many products available in everyday life and at job sites are often fastened bolts and screw caps. The sleeves for loosening and fixing bolts and screw caps are widely applied in these occasions.

Given the fact that, for a variety of bolts, a sleeve assembly can be inserted into the same tool handle, there is a lot of flexible changing by the operator.

As the sleeve assembly containing a plurality of sleeves is placed into a tool kit, the operator may find it difficult to fetch the sleeves due to either metric/English system or different sizes. For this reason, some sleeve structures with identification functions are developed in this industry.

In addition to above-mentioned identification functions, some snapping mechanisms, such as steel balls and springs, are incorporated on the sleeve structure, such that the sleeve and tool can be assembled more securely and stably. However, some auxiliary parts are required to assist the snapping mechanism in realizing the stabilizing effect, leading to higher complexity of the sleeve structure, increased material costs and more assembly expenses as well as poorer robustness.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the innovative present invention, the connecting end of the locating spring is fixed between the identification ring and the cylinder of the sleeve body. The identification ring of the present invention enables users to identify the sleeve and also position the locating spring since the identification ring is sleeved onto the cylinder of the sleeve body. So, the sleeve with streamlined members has two additional efficacies: ease of identification and ease of positioning. Thus, costs are reduced, and the applicability and industrial benefits of the sleeve are improved.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows an assembled perspective view of the preferred embodiment of the present invention.

FIG. 3 shows an assembled sectional view of the preferred embodiment of the present invention.

FIG. 4 shows an assembled perspective view of the preferred embodiment of the present invention.

FIG. 5 shows an assembled sectional view of another preferred embodiment of the present invention.

FIG. 6 shows an assembled sectional view of another preferred embodiment of the present invention.

FIG. 7 shows an exploded perspective view of another preferred embodiment of the present invention.

FIG. 8 shows an exploded perspective view of another preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

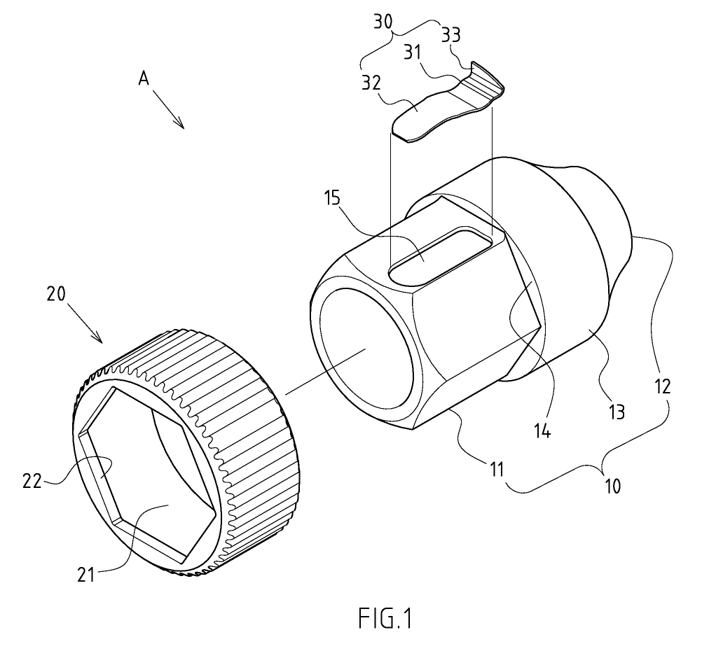

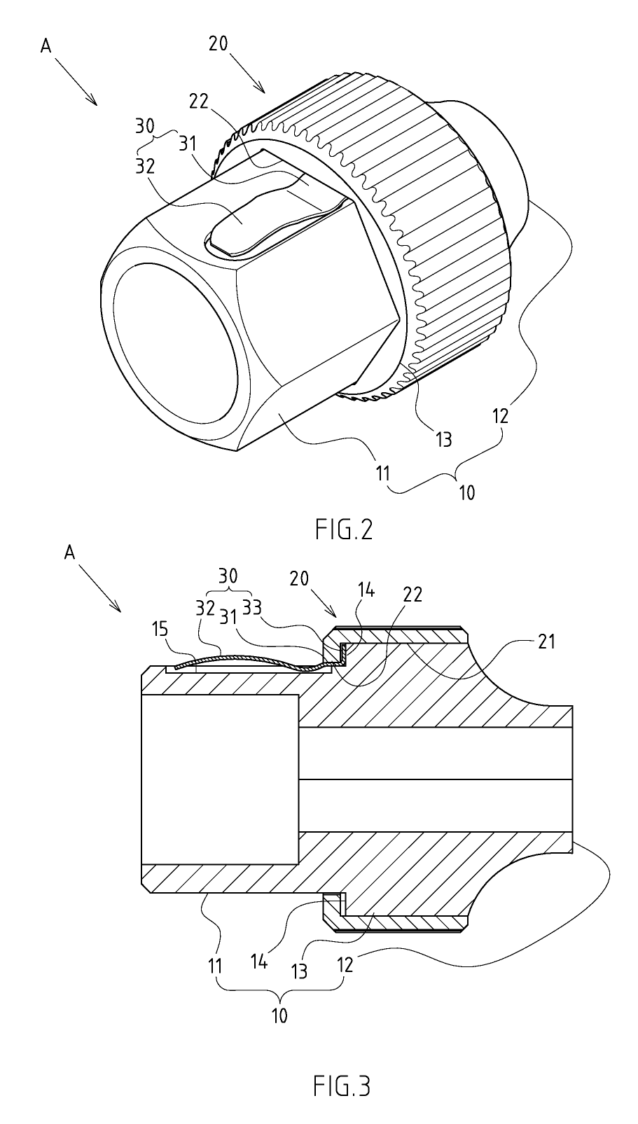

FIGS. 1-3 depict preferred embodiments of an improved sleeve structure of the present invention. The embodiment are provided only for explanatory purposes with respect to the patent claims.

The sleeve A comprises a sleeve body 10, containing a tool coupling end 11, an acting end 12 and a cylinder 13 between the tool coupling end 11 and acting end 12. The acting end 12 is generally a hexagonal hole, and the tool coupling end 11 is a hexagonal column.

An identification ring 20 is set into different colors to identify the size or metric/English units of the sleeve A. The identification ring 20 is provided with a through hole 21 for sleeving and positioning onto the cylinder 13 of the sleeve body 10.

A locating spring 30 is positioned by the identification ring 20. The locating spring 30 is provided with a connecting end 31 and a positioning end 32. The connecting end 31 is fixed between the identification ring 20 and the cylinder 13 of the sleeve body 10, while the positioning end 32 is extended to one side of the tool coupling end 11 of the sleeve body 10.

Referring to FIGS. 1-3, the connecting end 31 of the locating spring 30 is provided with a folding portion 33. A recessed flange 22 and a limiting shoulder 14 are arranged correspondingly to the through hole 21 of the identification ring 20 and the cylinder 13 of the sleeve body 10, so that the folding portion 33 can be fixed between the recessed flange 22 and limiting shoulder 14, as shown in FIG. 3.

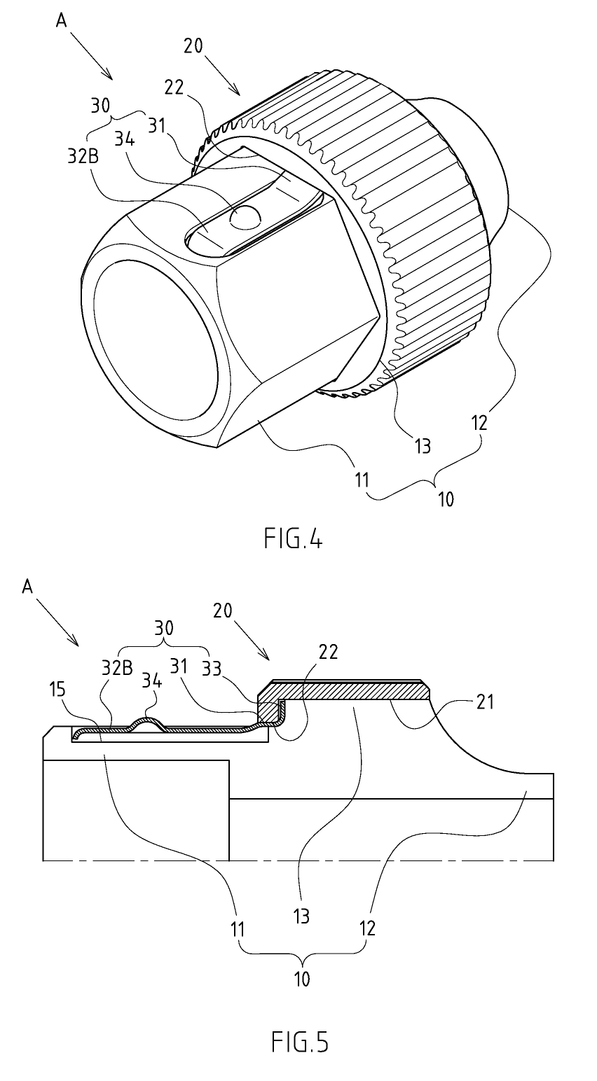

The positioning end 32 of the locating spring 30 is a curved arc sheet, as shown in FIGS. 1-3. Alternatively, the positioning end 32B of the locating spring 30 is a protruding flange 34 punched onto the sheet, as shown in FIGS. 4 and 5.

Referring to FIGS. 3 and 5, a groove 15 is arranged at one side of the tool coupling end 11 of the sleeve body 10, allowing the positioning end 32 (or 32B) of the locating spring 30 to be inserted. So, a recessed space is available when the positioning end 32 of the locating spring 30 is under a stressed state.

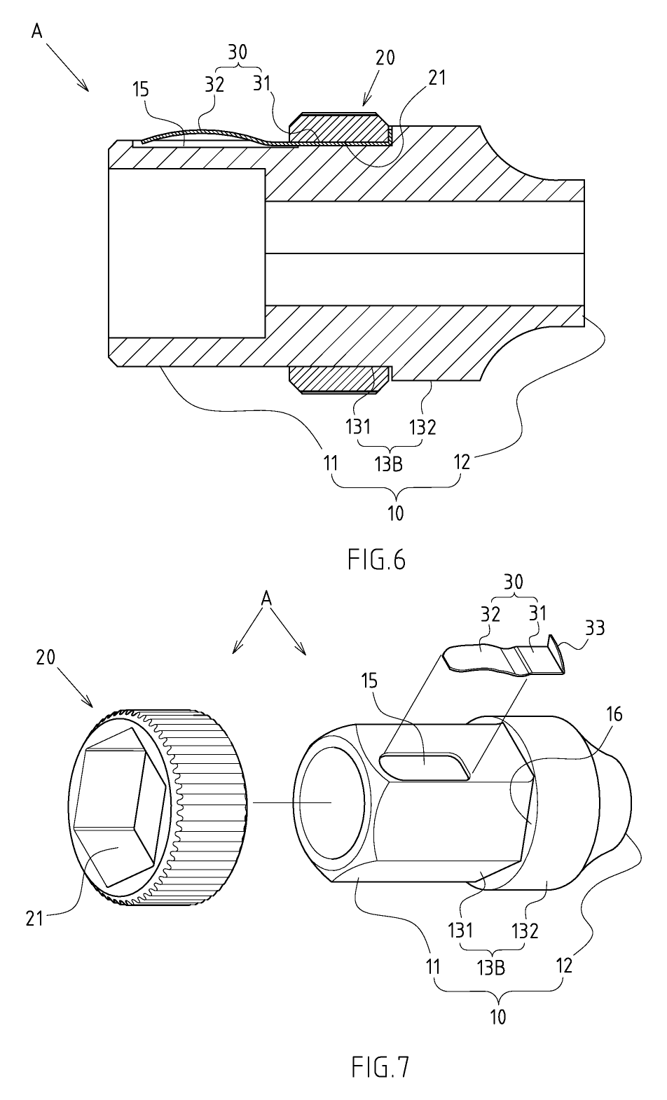

Referring to FIGS. 6 and 7, the cylinder 13B of the sleeve body 10 is comprised of a hexagonal section 131 and a cylindrical section 132. The external diameter of the cylindrical section 132 is bigger than that of the hexagonal section 131, and a retaining surface 16 is defined between the cylindrical section 132 and hexagonal section 131.

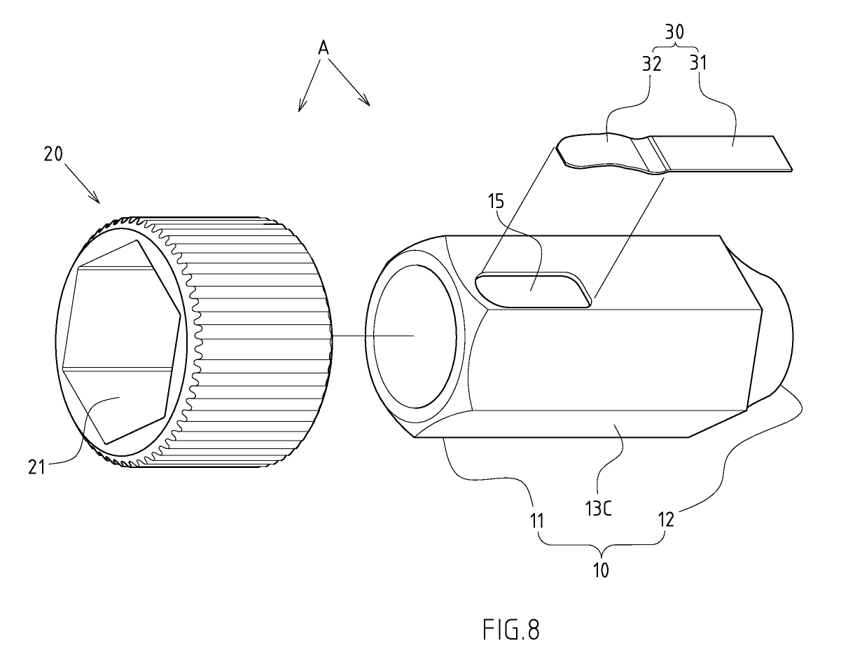

Referring to FIG. 8, the cylinder 13C of the sleeve body 10 is also of a hexagonal profile, which is flushed with the tool coupling end 11.

Based on above-specified structures, the sleeve structure of the present invention has two additional efficacies in application. First, the identification ring 20 allows the operator to identify easily the sizes or metric/English units of the sleeves. Second, the locating spring 30 and the through hole of existing tools (e.g. socket wrench) can be positioned securely. As the identification ring 20 can position the locating spring 30, the positioning members required for the locating spring 30 can be neglected, thereby saving the structural members and reducing the assembly process and cost.

1. A sleeve for labeling tools and fasteners, comprising:
a sleeve body, having a tool coupling end, an acting end and a cylinder between the tool coupling end and acting end;
an identification ring, being provided with a through hole for sleeving and positioning onto said cylinder of the sleeve body; and
a locating spring being positioned by said identification ring and being provided with a connecting end and a positioning end, said connecting end being fixed between said identification ring said cylinder of said sleeve body, said positioning end being extended to one side of said tool coupling end of said sleeve body.

2. The sleeve defined in claim 1, wherein said connecting end of said locating spring is provided with a folding portion, said folding portion having a recessed flange and a limiting shoulder arranged corresponding to said through hole of said identification ring and said cylinder of the sleeve body, said folding portion being fixed between said recessed flange and said limiting shoulder.

3. The sleeve defined in claim 1, wherein said positioning end of said locating spring is a curved arc sheet.

4. The sleeve defined in claim 1, wherein said positioning end of said locating spring is a protruding flange punched onto the sheet.

5. The sleeve defined in claim 1, wherein said cylinder of said sleeve body is comprised of a hexagonal section and a cylindrical section, an external diameter of said cylindrical section being bigger than an external diameter of said hexagonal section, and a retaining surface being defined between said cylindrical section and hexagonal section.

6. The sleeve defined in claim 1, wherein said cylinder of the sleeve body has a hexagonal profile.

7. The sleeve defined in claim 1, wherein said tool coupling end has a groove is arranged at one side thereof, allowing said positioning end of the locating spring to be inserted therein.
